(19) United States
(12) Patent Application Publication
(10) Pub. No.: US 2015/0208285 A1
(43) Pub. Date: Jul. 23, 2015

(54) APPARATUS AND METHOD FOR CIRCUIT SWITCHED FALLBACK

(71) Applicant: MediaTek Inc., Hsin-Chu (TW)

(72) Inventors: Shih-Chieh LIAO, Kaohsiung City (TW); Chih-Kuang WU, Jhubei City (TW); Chi-Chen LEE, Taipei City (TW)

(21) Appl. No.: 14/597,452

(22) Filed: Jan. 15, 2015

Related U.S. Application Data
(60) Provisional application No. 61/928,824, filed on Jan. 17, 2014.

(51) Int. Cl. H04W 36/00

(52) U.S. Cl. CPC H04W 36/0022; H04W 36/30

(57) ABSTRACT

The method and apparatus for CSFB are provided. The method for processing a Circuit Switched Fallback (CSFB) procedure in a user equipment (UE) includes the steps of receiving the switching command when the CSFB procedure is triggered to establish a CS call, and searching for a 2G/3G cell, when the UE fails to fall back to a target cell indicated by the switching command. In addition, the method for CSFB further includes the step of initiating a timer when the UE fails to fall back to the target cell indicated by the switching command, and searching for the 2G/3G cell until the timer is expired.

### CROSS REFERENCE TO RELATED APPLICATIONS

This Application claims priority of U.S. Provisional Patent Application No. 61/928,824, filed on Jan. 17, 2014, the entirety of which is incorporated by reference herein.

### BACKGROUND OF THE INVENTION

1. Field of the Invention

The invention generally relates to the circuit switched fallback (CSFB), and more particularly, to continuously searching for a 2G/3G cell in a 2G/3G network, when the UE fails to fall back to a target cell indicated by a switching command.

2. Description of the Related Art

With growing demand for mobile communications, the Global System for Mobile communications (GSM) supporting only circuit-switched (CS) domain services no longer meets user requirements. Accordingly, the mobile communications working groups and standard groups have developed the so-called third generation mobile communications technologies, such as Wideband Code Division Multiple Access (W-CDMA), Code Division Multiple Access-2000 (CDMA-2000), Time Division-Synchronous Code Division Multiple Access (TD-SCDMA), etc. Take the Universal Mobile Telecommunications System (UMTS) using the W-CDMA technology for example: the 3rd Generation Partnership Project (3GPP) has further proposed the Long Term Evolution (LTE) system, and called for the fourth generation mobile (4G) communications system to be implemented to meet future demand for large wireless data-transmission bandwidths. The LTE system aims to provide an all-IP architecture, in which only a packet-switched (PS) domain, instead of a CS domain, is used to carry all mobile communications services. Also, voice services are provided by Voice over Internet Protocol (VoIP) in the fourth generation mobile communications system, instead of the CS domain as per the second and third generation (2G/3G) mobile communications systems.

However, during transition from the second and third generation mobile communications systems to the fourth generation mobile communications system, some operators have still chosen to provide voice services via the CS domain of the second and third generation mobile communications systems, due to the coverage rate and capacity of the CS domain of the second and third generation mobile communications system being sufficient. This raises a problem wherein the architecture of the second and third generation mobile communications systems comprise both the CS domain and PS domain, while the fourth generation mobile communications system comprises only the PS domain. Accordingly, the interconnection between the second and third generation mobile communications systems and the fourth generation mobile communications system, especially the CS domain part, must be defined and specified, so that systems of different standards can achieve smooth interoperability to provide voice services to users. One technique used is the Circuit Switched Fallback (CSFB) architecture, which is defined in the 3GPP TS 23.272 specification.

The CSFB procedure has different solutions, such as the Redirection mechanism and Measurement mechanism (Handover or CellChangeOrder). In the Redirection mechanism, the LTE network may previously provide redirection information to the UE. In the Measurement mechanism, the LTE network may request the UE to perform an inter-Radio Access Technology (inter-RAT) measurement and send the measurement report to the LTE network.

In the Measurement mechanism, the UE may receive a command from the LTE network (4G network), e.g. a radio resource control (RRC) connection release message or Mobility From EUTRA Command message (containing handover (HO) or cell change order (CCO)) to fall back to the target cell. If the UE fails to fall back to the target cell indicated by the Mobility From EUTRA Command message, the UE needs to return to the LTE network to perform a RRC Connection reestablishment procedure. For the Mobile Originating (MO) CS call, if the UE fails to fall back to the target cell indicated in the Mobility From EUTRA Command message, before the UE selects GERAN or UTRAN radio access technology to make the MO CS call it needs to wait until the T3417ext timer is expired or the RRC connection fails. For the Mobile Terminating (MT) CS call, if the UE fails to fall back to the target cell of the Mobility From EUTRA Command, the MT CS call will fail.

Therefore, saving processing time when the UE fails to fall back to the target cell indicated by the Mobility From EUTRA Command message, and increasing the success rate of establishing CS calls are subjects worthy of discussion.

### BRIEF SUMMARY OF THE INVENTION

Apparatus and methods for CSFB are provided to overcome the problems mentioned above.

An embodiment of the invention provides a method for Circuit Switched Fallback (CSFB). The method for CSFB in a user equipment (UE) comprises the steps of receiving the switching command when a CSFB procedure is triggered to establish a CS call; and searching for a 2G/3G cell instead of returning to LTE network, when the UE fails to fall back to a target cell indicated by the switching command.

In the embodiment of the invention, the method for CSFB further comprises the step of initiating a timer, by the UE, when the UE fails to fall back to the target cell indicated by the switching command; and searching for the 2G/3G cell in the 2G/3G network until the timer is expired.

In the embodiment of the invention, the method for CSFB further comprises the step of storing measurement results of 2G/3G cells , before the CSFB procedure is triggered; and checking whether the quality value of the target cell is higher than a threshold according to the 2G/3G cell measurement result. If the target cell has valid measurement result and the quality value of the target cell is higher than the threshold, an inter-radio access technology (inter-RAT) procedure will be performed to fall back to the target cell.

An embodiment of the invention provides an apparatus for Circuit Switched Fallback (CSFB), wherein the apparatus operates as a User Terminal (UE). The apparatus for CSFB comprises an RF signal processing device and a processor. The RF signal processing device is configured to receive a switching command when a CSFB procedure is triggered to establish a CS call. The processor is configured to search for a 2G/3G cell in the 2G/3G network when the UE fails to fall back to a target cell indicated by the switching command.

In the embodiment of the invention, the apparatus for CSFB further comprises a timer. The timer is initiated when the UE fails to fall back to the target cell indicated by the switching command. The processor searches for a 2G/3G cell in the 2G/3G network until the timer is expired.

In the embodiment of the invention, the apparatus for CSFB further comprises a memory device. The memory device is configured to store measurement results of 2G/3G cells, before the CSFB procedure is triggered. The processor checks whether a quality value of the target cell is higher than a threshold according to the measurement result of the target cell. If the quality value of the target cell is valid and higher than the threshold, the processor performs an inter-radio access technology (inter-RAT) procedure to fall back to the target cell. If the quality value of the target cell is valid but lower than the threshold the processor searches for the 2G/3G cell in the 2G/3G network.

Other aspects and features of the invention will become apparent to those with ordinary skill in the art upon review of the following descriptions of specific embodiments of communication transmission methods and systems.

### BRIEF DESCRIPTION OF THE DRAWINGS

The invention will become more fully understood by referring to the following detailed description with reference to the accompanying drawings, wherein:

FIG. 1 is a block diagram of a mobile communications system 100 for CSFB according to an embodiment of the invention;

FIG. 2A is a message sequence chart illustrating the CSFB procedure based on the Mobile Terminating (MT) CS call in a mobile communications system according to an embodiment of the invention;

FIG. 2B is a message sequence chart illustrating the CSFB procedure based on the Mobile Originating (MO) CS call in a mobile communications system according to an embodiment of the invention;

FIG. 3 is a flow chart illustrating the method for CSFB according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

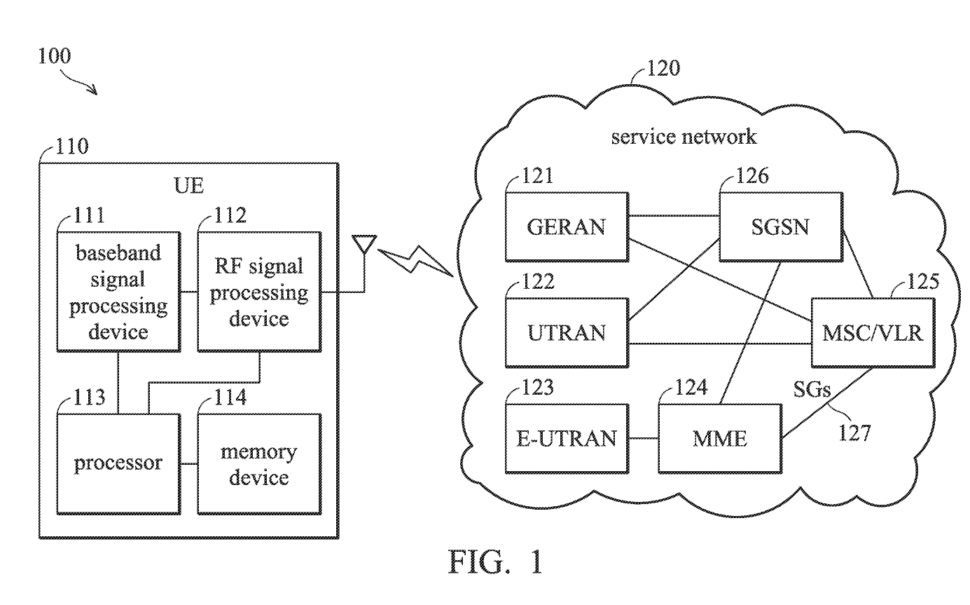

FIG. 1 is a block diagram of a mobile communications system 100 for CSFB according to an embodiment of the invention. The system 100 comprises a User Equipment (UE) 110, and a service network 120. The UE 110 may be a mobile communications device, such as a cellular phone, a smartphone modem processor, a data card, a laptop stick, a mobile hotspot, a USB modem, a tablet, etc.

The UE 110 may comprise at least a baseband signal processing device 111, a radio frequency (RF) signal processing device 112, a processor 113, a memory device 114, and an antenna module comprising at least one antenna. Note that, in order to clarify the concept of the invention, FIG. 1 presents a simplified block diagram in which only the elements relevant to the invention are shown. However, the invention should not be limited to what is shown in FIG. 1.

The RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, etc.

The baseband signal processing device 111 may further process the baseband signals to obtain information or data transmitted by the peer communications apparatus. The baseband signal processing device 111 may also comprise a plurality of hardware elements to perform baseband signal processing. The baseband signal processing may comprise analog-to-digital conversion (ADC)/digital-to-analog conversion (DAC), gain adjustment, modulation/demodulation, encoding/decoding, and so on.

The processor 113 may control the operations of the baseband signal processing device 111 and the RF signal processing device 112. According to an embodiment of the invention, the processor 113 may also be arranged to execute the program codes of the software module(s) of the corresponding baseband signal processing device 111 and/or the RF signal processing device 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software module(s).

The memory device 114 may store the software and firmware program codes, system data, user data, etc. of the UE 110. The memory device 114 may be a volatile memory, e.g. a Random Access Memory (RAM), or a non-volatile memory, e.g. a flash memory, Read-Only Memory (ROM), or hard disk, or any combination thereof. In an embodiment of the invention, the memory device 114 stores measurement results of 2G/3G cells, before the CSFB procedure is triggered, wherein the measurement results of 2G/3G cells are collected when the UE 110 camps on the 4G network (LTE network). In an embodiment of the invention, the 2G measurement result comprises the physical cell identity (PCI), received signal strength indicator (RSSI) information, and so on. In an embodiment of the invention, the 3G measurement result comprises the physical cell identity (PCI) and received signal code power (RSCP) information, Ec/No, and so on.

According to an embodiment of the invention, the RF signal processing device 112 and the baseband signal processing device 111 may be collectively regarded as a radio module capable of communicating with a wireless network to provide wireless communications services in compliance with a predetermined Radio Access Technology (RAT). Note that, in some embodiments of the invention, the UE 110 may further be extended to comprise more than one antenna and/or more than one radio module, and the invention should not be limited to what is shown in FIG. 1.

In addition, in some embodiments of the invention, the processor 113 may be configured inside of the baseband signal processing device 111, or the UE 110 may comprise another processor configured inside of the baseband signal processing device 111. Thus the invention should not be limited to the architecture as shown in FIG. 1.

The service network 120 comprises a GSM EDGE Radio Access Network (GERAN) 121, a Universal Terrestrial Radio Access Network (UTRAN) 122, an Evolved Universal Terrestrial Radio Access Network (E-UTRAN) 123, a mobility management entity (MME) 124, a mobile switching center (MSC)/visitor location register (VLR) 125, and a serving general packet radio service (GPRS) support node (SGSN) 126. The MME 124 communicates with the MSC/VLR 125 via a SGs interface 127. In the CSFB process, the UE 110 may use the GERAN 121 or the UTRAN 122 to connect to the CS domain, and use the E-UTRAN 123 to connect to a packet switched (PS) domain (e.g., a long term evolution (LTE) network). When CS services, e.g. a mobile terminating voice call, are processed, a page for CS services is received from the MSC 125, it is forwarded to the UE 110 via the MME 124 (using the SGs-interface 127) and then the UE 110 performs fallback to GERAN 121 or UTRAN 122 and responds to paging via the selected RAN (Radio Access Network). Similar behavior applies for CS services originating in the UE 110. When these are triggered and the UE 110 is camping on E-UTRAN 123, the UE 110 performs fallback to GERAN 121 or UTRAN 122 and triggers initiation of the CS service there.

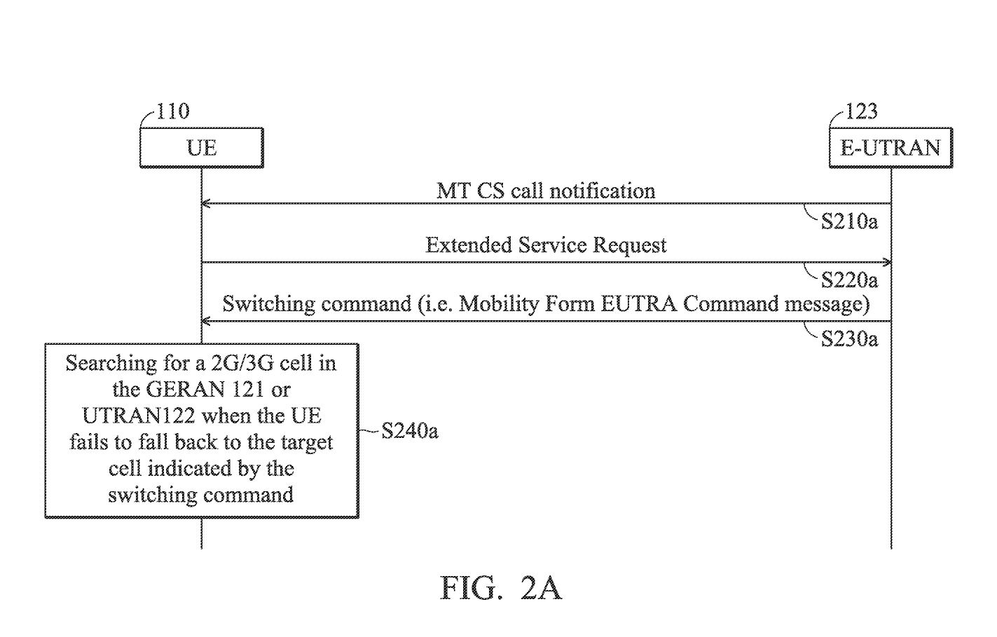

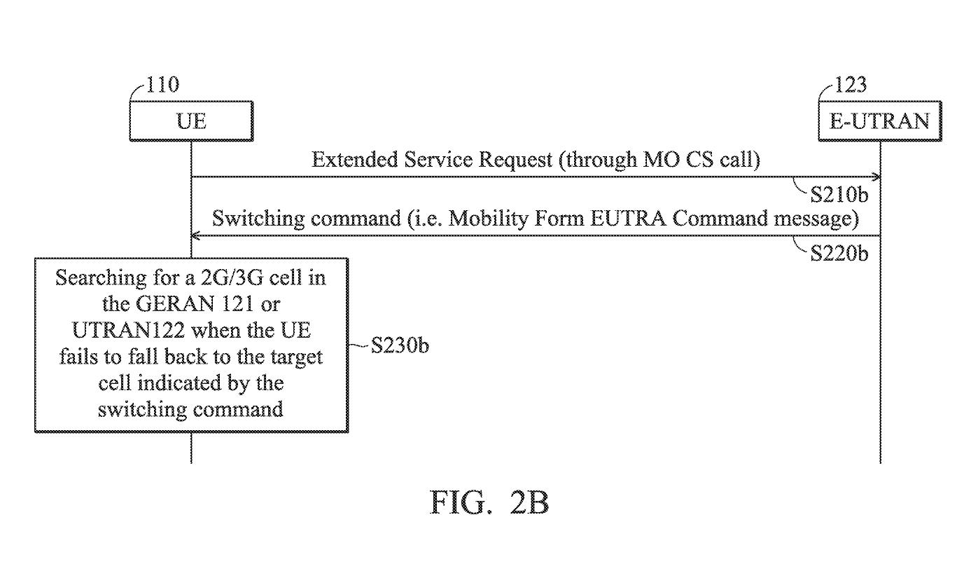

FIG. 2A is a message sequence chart illustrating the CSFB procedure based on the Mobile Terminating (MT) CS call in a mobile communications system according to an embodiment of the invention. First, the UE 110 may receive a MT CS call notification from the E-UTRAN 123 (LTE network) (step S210a). Then the UE 110 shall initiate the CSFB procedure by sending Extended Service Request message to the E-UTRAN 123 (step S220a). After the network 120 accepts the CSFB procedure, the E-UTRAN 123 may transmit a switching command (i.e. Mobility Form EUTRA Command message) to the UE 110 to indicate the UE 110 to fall back to a target cell of the GERAN 121 (2G network) or UTRAN 122 (3G network) according to the switching command (step S230a).

When the UE 110 fails to fall back to the target cell indicated by the switching command, the UE 110 will start to search for a 2G/3G cell in the GERAN 121 or UTRAN 122 without returning to the E-UTRAN 123 (step S240a). In the embodiment of the invention, the UE 110 further comprises a timer. The UE 110 will initiate a timer, when the UE 110 fails to fall back to the target cell indicated by the switching command. Then, the UE 110 may search for the cell in the GERAN 121 or UTRAN 122 until the timer is expired. In the embodiment of the invention, a count value of the timer is about 5-10 sec. In the embodiment of the invention, if the UE 110 finds the 2G/3G cell in the GERAN 121 or UTRAN 122, the MT CS call maybe established on this 2G/3G cell. If the UE 110 doesn't find the 2G/3G cell in the GERAN 121 or UTRAN 122, the UE 110 will abort the MT CS call. In addition, if the timer expires and the UE 110 still hasn't found the 2G/3G cell in the GERAN 121 or UTRAN 122, the UE 110 will also abort the MT CS call.

FIG. 2B is a message sequence chart illustrating the CSFB procedure based on the Mobile Originating (MO) CS call in a mobile communications system according to an embodiment of the invention. First, the UE 110 may trigger the CSFB procedure by sending Extended Service Request message to the E-UTRAN 123 through a MO CS call (step S210b). After the UE 110 triggers the CSFB procedure by the MO CS call, the E-UTRAN 123 may transmit a switching command (i.e. Mobility Form EUTRA Command message) to the UE 110 to indicate the UE 110 to fall back to a target cell of the GERAN 121 (2G network) or UTRAN 122 (3G network) according to the switching command (step S220b).

When the UE 110 fails to fall back to the target cell indicated by the switching command, the UE 110 will start to search for a 2G/3G cell in the GERAN 121 or UTRAN 122 without returning to E-UTRAN 123 (step S230b). In the embodiment of the invention, the UE 110 further comprises a timer. The UE 110 will initiate a timer, when the UE 110 fails to fall back to the target cell indicated by the switching command. Then, the UE 110 may search for the 2G/3G cell in the GERAN 121 or UTRAN 122 until the timer is expired. In the embodiment of the invention, a count value of the timer is about 5-10 sec. In the embodiment of the invention, if the UE 110 finds the 2G/3G cell in the GERAN 121 or UTRAN 122, the MO CS call will be established on this 2G/3G cell. If the UE 110 doesn't find the 2G/3G cell in the GERAN 121 or UTRAN 122, the UE 110 will abort the MO CS call. In addition, if the timer expires and the UE 110 still hasn't found the 2G/3G cell in the GERAN 121 or UTRAN 122, the UE 110 will also abort the MO CS call.

In some embodiments of the invention, after receiving the switching command (step S230a and step S220b), the UE 110 may check whether a quality value of the target cell is higher than a threshold according to the measurement results of 2G/3G cells stored in the memory device 114. That is to say, when the UE 110 obtains related information of the target cell indicated by the switching command, the UE 110 may determine the quality of the target cell indicated by the switching command is good or bad according to the measurement results of 2G/3G cells stored in the memory device 114 first. If the UE 110 determine that the quality of the target cell is good enough (higher than the threshold) according to the stored measurement results of 2G/3G cells, the UE 110 will perform an original inter-radio access technology (inter-RAT) procedure (i.e. handover or Cell Change Order) to fall back to the target cell. In addition, when UE 110 performs the original inter-RAT procedure and the UE 110 fails to fall back to the target cell indicated by the switching command in the original inter-RAT procedure, the UE 110 will start to search for a 2G/3G cell in the GERAN 121 or UTRAN 122 without returning to E-UTRAN 123 (step S240a and step S230b). If the UE 110 determines that the quality of the target cell is bad (lower than the threshold) according to the stored measurement results of 2G/3G cells, the UE 110 will omit the target cell indicated by the switching command and start to search for a 2G/3G cell in the GERAN 121 or UTRAN 122 without returning to E-UTRAN 123 (step S240a and step S230b).

In some embodiments of the invention, the UE 110 searches for a 2G/3G cell in the GERAN 121 or UTRAN 122 according to the stored measurement results of 2G/3G cells or the stored frequency information stored in the memory device 114, when the UE 110 fails to fall back to the target cell indicated by the switching command. In an embodiment of the invention, the UE 110 may search the 2G/3G cell in the GERAN 121 or UTRAN 122 according to the stored measurement results of 2G/3G cells first. If the UE 110 fails to fall back to the 2G/3G cell in the GERAN 121 or UTRAN 122 due to the UE cannot find a suitable 2G/3G cell to setup MO/MT CSFB call according to the stored measurement results of 2G/3G cells, the UE 110 may search for a suitable 2G/3G cell in the GERAN 121 or UTRAN 122 according to the stored frequency information sequentially. The UE 110 may search the 2G/3G cells which have been camped on according to the stored frequency information to find a suitable 2G/3G cell to fall back. In an embodiment of the invention, the UE 110 may search for the 2G/3G cell in the GERAN 121 or UTRAN 122 by performing full band search operation, if the UE 110 fails to fall back to the 2G/3G cell according to the stored measurement results of 2G/3G cells or the stored frequency information. In the full band search operation, the UE 110 will search all cells in the all supported bands. If the UE 110 still doesn't find the 2G/3G cell in the GERAN 121 or UTRAN 122 after searching all cells in the bands, the UE 110 will abort the MT CS call or MO CS call.

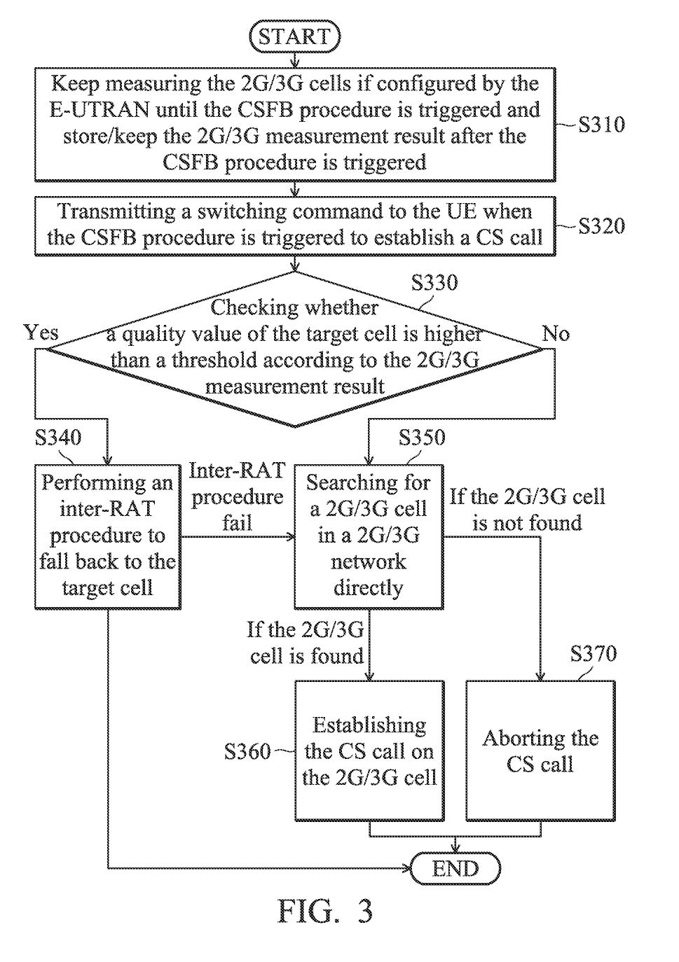

FIG. 3 is a flow chart illustrating the method for CSFB according to an embodiment of the invention. The method for CSFB is applied to the mobile communications system 100. First, in step S310, the UE 110 may keep measuring the 2G/3G cells if configured by the E-UTRAN 123 until the CSFB procedure is triggered and store/keep the 2G/3G measurement result after the CSFB procedure is triggered. In step S320, when the CSFB procedure is triggered to establish a CS call (e.g. MT CS call or MO CS call), the E-UTRAN 123 (LTE network or 4G network) may transmit a switching command (i.e. Mobility Form EUTRA Command message) to the UE 110. In step S330, when the CSFB procedure has been triggered, the UE 110 may check whether a quality value of the target cell is higher than a threshold according to the measurement result of 2G/3G cells stored in the memory device 114.

If the quality value of the target cell is higher than the threshold, step S340 will be performed. In step S340, the UE 110 performs an inter-RAT procedure (i.e. handover or Cell Change Order) to fall back to the target cell. If the quality value of the target cell is lower than the threshold, step S350 will be performed. In step S350, the UE 110 will search for a 2G/3G cell in a 2G/3G network directly (omit the target cell indicated by the switching command). If the 2G/3G cell is found by the UE 110, step S360 is performed. In step S360, the CS call will be established on the 2G/3G cell. If the 2G/3G cell is not found by the UE 110, step 5370 is performed. In step S370, the CS call will be aborted. In the embodiment of the invention, in step S340, if the UE 110 fails to fall back to the target cell in the inter-RAT procedure, step S350 will be performed.

In an embodiment of the invention, in step S350, the UE 110 further initiates a timer. In addition, in step S350, if the timer expires and the UE 110 still fails to find the 2G/3G cell, the CS call also will be aborted, step S370 will be performed. In an embodiment of the invention, in step S350, the UE 110 searches for a 2G/3G cell in a 2G/3G network according to the stored measurement result or the stored frequency information.

In a traditional CSFB procedure, if the LTE network indicates a target cell by transmitting a Mobility Form EUTRA Command message to the UE and the UE fails to fall back to the target cell, the UE needs to return to LTE network to perform an RRC Connection reestablishment procedure. However, in the method of the invention, the UE does not need to return to LTE network when the UE fails to fall back to the target cell. The UE may search for the 2G/3G cell in the 2G/3G network continuously to establish the CS call when the UE fails to fall back to the target cell. Therefore, in the method for CSFB of the invention, when the UE fails to fall back to the target cell, the CSFB procedure will be more efficient and the success rate of establishing CS calls will be increased.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for processing a Circuit Switched Fallback (CSFB) procedure in a user equipment (UE), comprising:
receiving a switching command when the CSFB procedure is triggered to establish a CS call; and
searching for a 2G/3G cell, when the UE fails to fall back to a target cell indicated by the switching command.

2. The method of claim 1, wherein the switching command is a handover switching commend or a CellChangeOrder (CCO) switching commend, and the target cell is indicated by the switching command.

3. The method of claim 1, further comprising:
initiating a timer when the UE fails to fall back to the target cell indicated by the switching command; and
searching for the 2G/3G cell until the timer is expired.

4. The method of claim 3, further comprising:
establishing the CS call on the 2G/3G cell, if the 2G/3G cell is found.

5. The method of claim 3, further comprising:
aborting the CS call, if the 2G/3G cell is not found or the timer is expired.

6. The method of claim 1, further comprising:
storing the measurement results of 2G/3G cells or frequency information corresponding to 2G/3G cells which have been camped on or received from a network, before the CSFB procedure is triggered.

7. The method of claim 6, further comprising:
checking whether a quality value of the target cell is higher than a threshold according to the stored measurement results of 2G/3G cells; and
performing an inter-radio access technology (inter-RAT) procedure to fall back to the target cell, if the quality value of the target cell is higher than the threshold.

8. The method of claim 7, further comprising:
searching for the 2G/3G cell in the 2G/3G network, if the UE fails to fall back to the target cell in the inter-RAT procedure.

9. The method of claim 7, further comprising:
searching for the 2G/3G cell, if the quality value of the target cell is lower than the threshold.

10. The method of claim 6, further comprising:
searching for the 2G/3G cell according to the stored measurement results of 2G/3G cells or the stored frequency information.

11. The method of claim 10, further comprising:
searching for the 2G/3G cell in supported frequency bands by a full band search operation, if the UE fails to fall back to the 2G/3G cell according to the stored measurement results of 2G/3G cells or the stored frequency information.

12. An apparatus for Circuit Switched Fallback (CSFB), operating as a User Terminal (UE), comprising:
an RF signal processing device, configured to receive a switching command when a CSFB procedure is triggered to establish a CS call;
a processor, configured to search for a 2G/3G cell in the 2G/3G network, when the UE fails to fall back to a target cell indicated by the switching command.

13. The apparatus for CSFB of claim 12, wherein the switching command is a handover switching commend or a CellChangeOrder (CCO) switching commend, and the target cell is indicated by the switching command.

14. The apparatus for CSFB of claim 12, wherein the processor initiates a timer when the UE fails to connect to the target cell indicated by the switching command and searches for the 2G/3G cell in the 2G/3G network until the timer is expired.

15. The apparatus for CSFB of claim 14, wherein the processor establishes the CS call on the 2G/3G cell, if the 2G/3G cell is found.

16. The apparatus for CSFB of claim 14, wherein the processor aborts the CS call, if the 2G/3G cell is not found or the timer is expired.

17. The apparatus for CSFB of claim 12, further comprising:
a memory device, configured to store the measurement results of 2G/3G cells and frequency information corresponding to 2G/3G cells which have been camped on or received from a network, before the CSFB procedure is triggered.

18. The apparatus for CSFB of claim 13, wherein the processor checks whether a quality value of the target cell is higher than a threshold according to the measurement result of 2G/3G cells, wherein the processor performs an inter-radio access technology (inter-RAT) procedure to fall back to the target cell, if the quality value of the target cell is higher than the threshold.

19. The apparatus for CSFB of claim 18, wherein the processor searches for the 2G/3G cell, if the UE fails to fall back to the target cell in the inter-RAT procedure.

20. The apparatus for CSFB of claim 18, wherein the processor searches for the 2G/3G cell, if the quality value of the target cell is lower than the threshold.

21. The apparatus for CSFB of claim 17, wherein the processor searches for the 2G/3G cell according to the stored measurement results of 2G/3G cells or the stored frequency information.

22. The apparatus for CSFB of claim 21, wherein the processor searches for the 2G/3G cell in supported frequency bands in the 2G/3G network by a full band search operation, if the UE fails to fall back to the 2G/3G cell according to the stored measurement results of 2G/3G cells or the stored frequency information.
